(19) United States
(12) Patent Application Publication
(10) Pub. No.: US 2007/0282645 A1
(43) Pub. Date: Dec. 6, 2007

(54) METHOD AND APPARATUS FOR QUANTIFYING COMPLEXITY OF INFORMATION

(76) Inventors: Aaron Baeten Brown, Croton-on-Hudson, NY (US); Yixin Diao, White Plains, NY (US); Robert Filepp, Westport, CT (US); Robert D. Kearney, Yorktown Heights, NY (US); Alexander Keller, New York, NY (US)

Correspondence Address: IBM CORPORATION, T.J. WATSON RESEARCH CENTER, P.O. BOX 218, YORKTOWN HEIGHTS, NY, 10598, US

(21) Appl. No.: 11/422,204

(22) Filed: Jun. 5, 2006

(51) Int. Cl. G06F 17/50

(52) U.S. Cl. 705/7

(57) ABSTRACT

The invention broadly and generally provides a method of quantifying the complexity of an information technology management process, the aforesaid method comprising: (a) obtaining process-related data for the aforesaid information technology management process; wherein the aforesaid process-related data defines: at least one task, at least one role, and any number of business items which can be transferred between a plurality of roles within the aforesaid at least one role while executing the aforesaid at least one task; (b) creating a set of process component complexity metrics by applying a process complexity model to the aforesaid process-related data, the aforesaid process complexity model comprising at least one relationship of properties selected from the roles, tasks, and business items; and (c) creating a value representing the complexity of the aforesaid information technology management process from the aforesaid set of process component complexity metrics. The method disclosed is particularly useful, where the aforesaid process-related data defines at least one task comprising a decision point.

### FIELD OF THE INVENTION

The present invention relates generally to computing system evaluation and, more particularly, to techniques for quantitatively measuring and benchmarking the complexity of processes used in information technology management.

### BACKGROUND OF THE INVENTION

The complexity of managing computing systems and information technology (IT) processes represents a major impediment to efficient, high-quality, error-free, and cost-effective service delivery ranging from small-business servers to global-scale enterprise backbones. IT systems and processes with a high degree of complexity demand human resources and expertise to manage that complexity, increasing the total cost of ownership. Likewise, complexity increases the amount of time that must be spent interacting with a computing system or between operators to perform the desired function, and decreases efficiency and productivity. Furthermore, complexity results in human errors, as complexity challenges human reasoning and results in erroneous decisions even by skilled operators.

Due to the high complexity level incurred in service delivery processes, it is evident that service providers are actively seeking to reduce the IT complexity by designing, architecting, implementing, and assembling systems and processes with minimal complexity level. In order to do so, they must be able to quantitatively measure and benchmark the degree of IT management complexity exposed by particular computing systems or processes, so that global delivery executives, program managers, and project leaders can evaluate the prospective complexity before investing in them, and designers, architects, and developers can rebuild and optimize them for reduced complexity. Besides improving decision making for projects and technologies, quantitative complexity evaluation can help computing service providers and outsourcers quantify the amount of human management that will be needed to provide a given service, allowing them to more effectively evaluate costs and set price points. All these scenarios require standardized, representative, accurate, easily-compared quantitative assessments of IT management complexity that involves human interaction and decision making. This motivates the need for a system and methods for quantifying complexity of information technology management processes.

Previous efforts directed to computing system evaluation provided no methods for quantifying complexity of information technology management processes. Well-studied computing system evaluation areas include system performance analysis, software complexity analysis, human-computer interaction analysis, dependability evaluation, and basic complexity evaluation.

System performance analysis attempts to compute quantitative measures of the performance of a computer system, considering both hardware and software components. This is a well-established area rich in analysis techniques and systems. However, none of these methodologies and systems for system performance analysis considers complexity-related aspects of the system under evaluation, nor do they collect or analyze complexity-related data. Therefore, system performance analysis provides no insight into the complexity of the IT management being evaluated.

Software complexity analysis attempts to compute quantitative measures of the complexity of a piece of software code, considering both the intrinsic complexity of the code, as well as the complexity of creating and maintaining the code. However, processes for software complexity analysis do not collect management-related statistics or data and therefore provides no insight into the management complexity of the computing systems and processes running the analyzed software.

Human-computer interaction (HCI) analysis attempts to identify interaction problems between human users and computer systems, typically focusing on identifying confusing, error-prone, or inefficient interaction patterns. However, HCI analysis focuses on detecting problems in human-computer interaction rather than performing an objective, quantitative complexity analysis of that interaction. HCI analysis methods are not designed specifically for measuring management complexity, and typically do not operate on management-related data. In particular, HCI analysis collects human performance data from costly observations of many human users, and does not collect and use management-related data directly from a system under test. Additionally, HCI analysis typically produces qualitative results suggesting areas for improvement of a particular user interface or interaction pattern. Thus, it does not produce quantitative results that evaluate an overall complexity of managing a system, independent of the particular user interface experience. The Model Human Processor approach to HCI analysis does provide objective, quantitative results; however, these results quantify interaction time for motor-function tasks like moving a mouse or clicking an on-screen button, and thus do not provide insight into the complexity of managing computing system and service management.

Dependability evaluation combines aspects of objective, reproducible performance benchmarking with HCI analysis techniques with a focus on configuration-related problems, see, e.g., Brown et al., “Experience with Evaluating Human-Assisted Recovery Processes,” Proceedings of the 2004 International Conference on Dependable Systems and Networks, Los Alamitos, Calif., IEEE, 2004. This approach includes a system for measuring configuration quality as performed by human users, but does not measure configuration complexity and does not provide reproducibility or objective measures.

Basic complexity evaluation quantitatively evaluates complexity of computing system configuration, see, e.g., Brown et al., “System and methods for quantitatively evaluating complexity of computing system configuration,” Ser. No. 11/205,972, filed on Aug. 17, 2005, and Brown et al., “System and methods for integrating authoring with complexity analysis for computing system operation procedures.” However, they do not provide metrics that quantify the complexity involved in human interaction and decision making.

### SUMMARY OF THE INVENTION

The invention broadly and generally provides a method of quantifying the complexity of an information technology management process, the aforesaid method comprising: (a) obtaining process-related data for the aforesaid information technology management process; wherein the aforesaid process-related data defines: at least one task, at least one role, and any number of business items which can be transferred between a plurality of roles within the aforesaid at least one role while executing the aforesaid at least one task; (b) creating a set of process component complexity metrics by applying a process complexity model to the aforesaid process-related data, the aforesaid process complexity model comprising at least one relationship of properties selected from the roles, tasks, and business items; and (c) creating a value representing the complexity of the aforesaid information technology management process from the aforesaid set of process component complexity metrics. The method disclosed is particularly useful, where the aforesaid process-related data defines at least one task comprising a decision point.

Advantageously, the aforesaid set of process component complexity metrics may comprise: (a) obtaining at least one business item complexity metric; (b) obtaining at least one coordination complexity metric; and (c) obtaining at least one execution complexity metric. Obtaining at least one business item complexity metric may comprise: (a) identifying parameters that comprise a business item; (b) providing a source score based on the type of source providing data for each of the aforesaid parameters; and (c) aggregating the aforesaid source scores. Obtaining at least one coordination complexity metric may comprise: (a) identifying the number of roles; and (b) identifying the number of business items. Obtaining at least one execution complexity metric may comprise: (a) identifying the level of automation; (b) identifying a context switch; and (c) obtaining a decision score; the aforesaid decision score reflecting whether decision-making is necessary.

Within an exemplary method, consistent with the disclosed invention, obtaining at least one coordination complexity metric may comprise: (a) identifying at least one role involved within a task; (b) identifying a set of transferred business items containing at least one business item which is transferred between a plurality of roles involved within the aforesaid task; (c) determining a type for each business item contained within the aforesaid set of transferred business items; and (d) determining a level of adaptation for each business item contained within the aforesaid set of transferred business items. Obtaining at least one execution complexity metric may comprise: (a) providing an automation value; the aforesaid automation value identifying a level of automation involved within a task; (b) providing a context switch value to indicate whether a context switch is required between tasks; (c) providing a decision score which identifies whether decision making is necessary; and (d) aggregating the aforesaid automation value, the aforesaid context switch value, and the aforesaid decision score. The aforesaid decision score might, for example, comprise the following factors: (a) the type of decision; (b) the business items involved in the decision; and (c) the level of guidance provided to facilitate making the decision.

The invention further broadly and generally provides a process complexity analyzer comprising: (a) a reader for obtaining process-related data for an information technology management process; (b) a process component metric generator, which creates at least one process component metric from the aforesaid process properties; and (c) a combiner, which creates a value representing the complexity of the aforesaid information technology management process from the aforesaid at least one process component metric.

The invention further broadly and generally provides a program storage device readable by a digital processing apparatus and having a program of instructions which are tangibly embodied on the storage device and which are executable by the processing apparatus to perform a method of quantifying the complexity of an information technology management process, the aforesaid method comprising: (a) obtaining process-related data for the aforesaid information technology management process; wherein the aforesaid process-related data defines: at least one task, at least one role, and any number of business items which can be transferred between a plurality of roles within the aforesaid at least one role while executing the aforesaid at least one task; (b) creating a set of process component complexity metrics by applying a process complexity model to the aforesaid process-related data, the aforesaid process complexity model comprising at least one relationship of properties selected from the roles, tasks, and business items; and (c) creating a value representing the complexity of the aforesaid information technology management process from the aforesaid set of process component complexity metrics.

### BRIEF DESCRIPTION OF THE DRAWINGS

FIG. 1 is an illustrative example of information technology management processes.

FIG. 2 is a flow diagram illustrating the overall process of quantifying complexity of information technology management processes.

FIG. 3 is a block diagram illustrating the process complexity model.

FIG. 4 is a flow diagram illustrating the steps for quantifying the business item complexity.

FIG. 5 is a flow diagram illustrating the steps for quantifying the coordination complexity.

FIG. 6 is a flow diagram illustrating the steps for quantifying the execution complexity.

### DETAILED DESCRIPTION OF PREFERRED EMBODIMENT

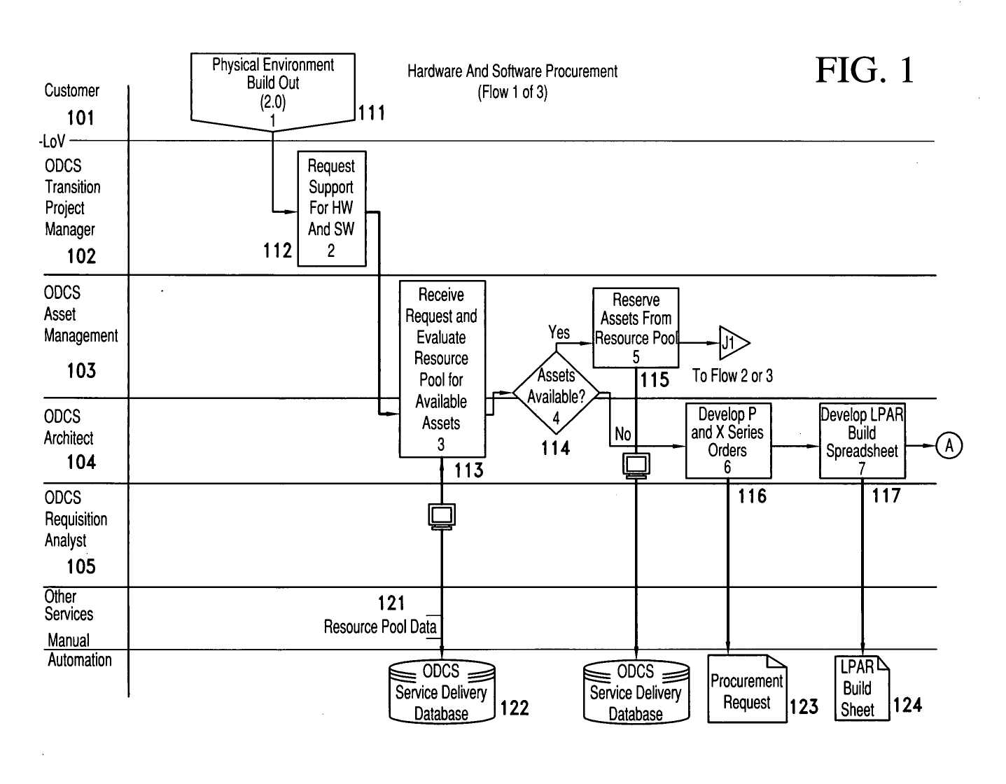

FIG. 1 is an illustrative example of an information technology management process. This process involves different roles such as customer (101), ODCS transition project manager (102), ODCS asset management (103), ODCS architect (104), and ODCS requisition analyst (105). The information technology management process is composed of multiple tasks such as physical environment build out (111), request support for hardware and software (112), receive request and evaluate resource pool for available assets (113), evaluate if assets are available (114), reserve assets from resource pool (115), develop P and X series orders (116), and develop LPAR build spreadsheet (117). Furthermore, each activity may consume or produce business items that are produced or consumed by other activities. Examples are resource pool data (121) stored in ODCS service delivery database (122), procurement request (123), and LPAR build sheet (124).

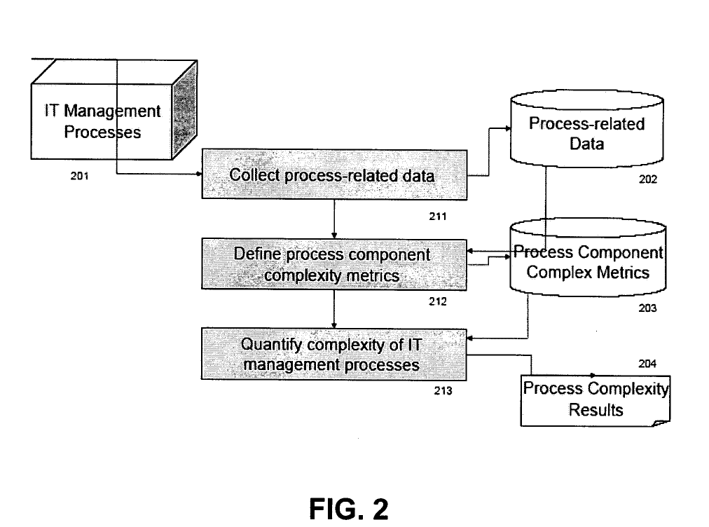

FIG. 2 is a flow diagram illustrating the overall process of quantifying complexity of information technology management processes. The process begins by collecting process-related data which is obtained from the information technology management processes (201). The collected process-related data (202) is then used to define a set of process component complexity metrics (203) by integrating the process-related data based on a process complexity model (212). The final step includes quantifying the complexity of the information technology management process from the process component complexity metrics (213) and generating process complexity results (204).

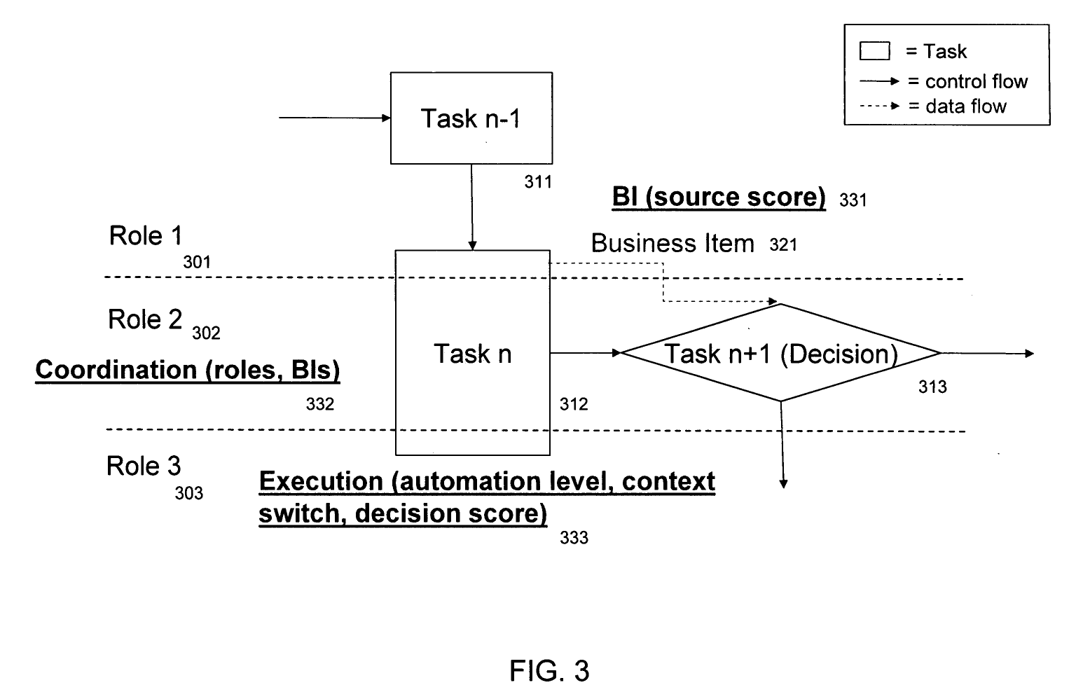

FIG. 3 is a block diagram illustrating the process complexity model. It includes multiple roles such as role 1 (301), role 2 (302), and role 3 (303); multiple tasks such as task n−1 (311), task n (312), and task n+1 (313). Note that a task can be a decision point which generates multiple branches. It also includes business items such as (321). Generally, a task is conducted by one role, even if this may involve interaction with multiple roles. A task may further comprise multiple action steps, which can consume different parameters as well.

The overall complexity of the information technology management process is composed of the process component complexity metrics that are defined along the control flow for each task. For example, the business item complexity metric comprises source scores of parameters, the coordination complexity metric comprises the number of roles and the number or business items, and the execution complexity metric comprises the level of automation, context switch, and decision score.

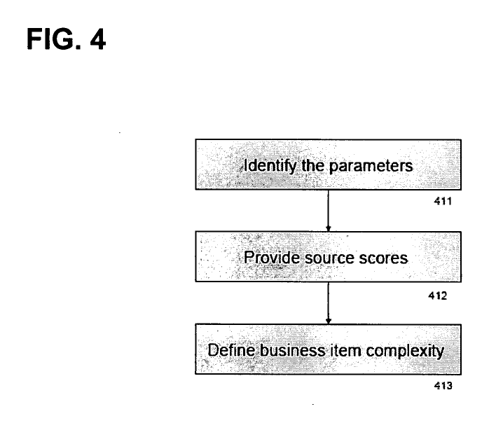

FIG. 4 is a flow diagram illustrating the steps for quantifying the business item complexity. It includes identifying the parameters that compose said business item (401), providing a source score based on the type of source that provides the data for each parameter (402), and aggregating all the source scores to obtain said business item complexity (403).

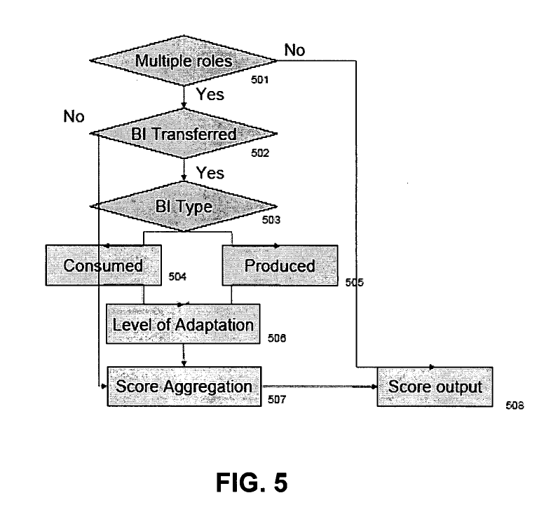

FIG. 5 is a flow diagram illustrating exemplary steps for quantifying the coordination complexity. In this example, coordination complexity is quantified per task; afterwards, all task coordination complexity is aggregated to compose the process coordination complexity. It includes the steps of identifying the roles involved within a task (501), selecting the business items transferred between a pair of roles (502), determining the type of business items being transferred (503), determining whether the business items are consumed (504) or produced (505) because those produced are often more complicated to transfer (as they generally require multi-way agreement), considering the level of adaptation required for transfer (506), aggregating said business item type and level of adaptation to define said coordination complexity metric (507), and outputting the coordination complexity (508).

The level of adaptation sub-metric can be an inquiry into what transformations might be required in order to transfer the business item. For example, retyping or scanning a hard-copy page of text would be considered to require a higher level of adaption than would simply cutting and pasting that same text from one window to another or from one table to another.

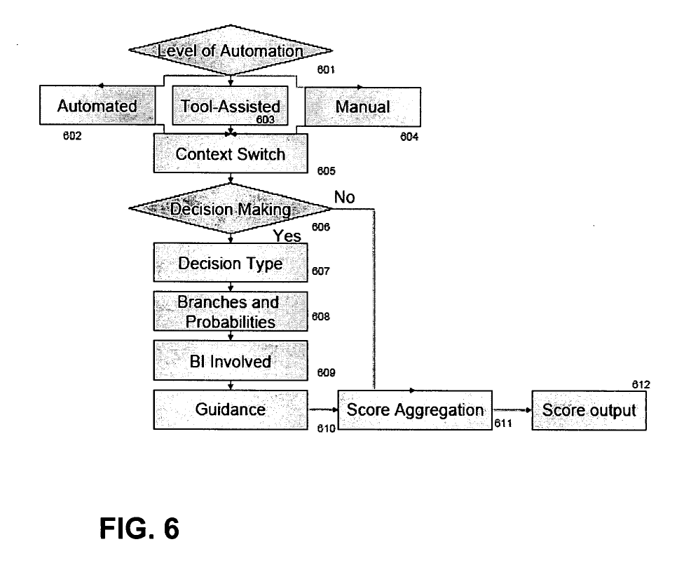

FIG. 6 is a flow diagram illustrating the steps for quantifying the execution complexity. It includes the steps of identifying the level of automation involved within a task (601), identifying which steps can be automated (602), tool-assisted (603), and manual (604), determining if a context switch is involved from the previous task (605), and providing a decision score if decision making is involved (606). Specifically, for example, a decision score can be determined by considering the decision type (607), branches and probabilities (608), business items involved (609), and the level of guidance (610), and computed using the following equation.

D=(typeFactor)*(nBranches−1)*(prFactor)*(gFactor)

where typeFactor depends on the type of criteria used to make the decision, nBranches is the number of output branches on the decision, prFactor measures the degree to which there's a common/obvious decision path, based on variance, and gFactor reflects level of decision guidance. For example, the gFactor can be defined as follows.
0.5: explicit goal-relevant information provided
1: general guidance on decision-making provided (abstracted from goal)
2: no guidance provided
Multiply by 2 if consequences of decision are not visible or explained

The information is then aggregated to define the execution complexity metric (611) and the execution complexity (612) is output.

While changes and variations to the embodiments may be made by those skilled in the field of information technology management, the scope of the invention is to be determined by the appended claims.

What is claimed is:

1. A method of quantifying the complexity of an information technology management process, said method comprising:
(a) obtaining process-related data for said information technology management process; wherein said process-related data defines: at least one task, at least one role, and any number of business items which can be transferred between a plurality of roles within said at least one role while executing said at least one task;
(b) creating a set of process component complexity metrics by applying a process complexity model to said process-related data, said process complexity model comprising at least one relationship of properties selected from the roles, tasks, and business items; and
(c) creating a value representing the complexity of said information technology management process from said set of process component complexity metrics.

2. A method as set forth in claim 1, wherein said process-related data defines at least one task comprising a decision point.

3. A method as set forth in claim 1, wherein creating said set of process component complexity metrics comprises:
(a) obtaining at least one business item complexity metric;
(b) obtaining at least one coordination complexity metric; and
(c) obtaining at least one execution complexity metric.

4. A method as set forth in claim 3, wherein obtaining at least one business item complexity metric comprises:
(a) identifying parameters that comprise a business item;
(b) providing a source score based on the type of source providing data for each of said parameters; and
(c) aggregating said source scores.

5. A method as set forth in claim 3, wherein obtaining at least one coordination complexity metric comprises:
(a) identifying the number of roles; and
(b) identifying the number of business items.

6. A method as set forth in claim 3, wherein obtaining at least one execution complexity metric comprises:
(a) identifying the level of automation;
(b) identifying a context switch; and
(c) obtaining a decision score; said decision score reflecting whether decision-making is necessary.

7. A method as set forth in claim 3, wherein obtaining at least one coordination complexity metric comprises:
(a) identifying at least one role involved within a task;
(b) identifying a set of transferred business items containing at least one business item which is transferred between a plurality of roles involved within said task;
(c) determining a type for each business item contained within said set of transferred business items; and
(d) determining a level of adaptation for each business item contained within said set of transferred business items.

8. A method as set forth in claim 3, wherein obtaining at least one execution complexity metric comprises:
(a) providing an automation value; said automation value identifying a level of automation involved within a task;
(b) providing a context switch value to indicate whether a context switch is required between tasks;
(c) providing a decision score which identifies whether decision making is necessary; and
(d) aggregating said automation value, said context switch value, and said decision score.

9. A method as set forth in claim 8, wherein said decision score comprises the following factors:
(a) the type of decision;
(b) the business items involved in the decision; and
(c) the level of guidance provided to facilitate making the decision.

10. A process complexity analyzer comprising:
(a) a reader for obtaining process-related data for an information technology management process;
(b) a process component metric generator, which creates at least one process component metric from said process properties; and
(c) a combiner, which creates a value representing the complexity of said information technology management process from said at least one process component metric.

11. A program storage device readable by a digital processing apparatus and having a program of instructions which are tangibly embodied on the storage device and which are executable by the processing apparatus to perform a method of quantifying the complexity of an information technology management process, said method comprising:
(a) obtaining process-related data for said information technology management process; wherein said process-related data defines: at least one task, at least one role, and any number of business items which can be transferred between a plurality of roles within said at least one role while executing said at least one task;
(b) creating a set of process component complexity metrics by applying a process complexity model to said process-related data, said process complexity model comprising at least one relationship of properties selected from the roles, tasks, and business items; and
(c) creating a value representing the complexity of said information technology management process from said set of process component complexity metrics.
